(19) United States
(12) Patent Application Publication
(10) Pub. No.: US 2026/0228448 A1
(43) Pub. Date: Aug. 6, 2026

(54) SYSTEM AND METHOD FOR HIGH SCALE AUTORESPONDER VIA LARGE LANGUAGE MODELS

(71) Applicant: YAHOO ASSETS LLC, New York, NY (US)

(72) Inventors: Gregory Wester, San Francisco, CA (US); Umang Jayesh Patel, Sunnyvale, CA (US); Jack Culpepper, Berkeley, CA (US); Bhopal Singh, San Jose, CA (US); Nirmal Thangaraj, Milpitas, CA (US); Yung Lin, Saratoga, CA (US); Carol Wang, San Jose, CA (US); Yitong Wang, South Plainfield, NJ (US)

(21) Appl. No.: 19/047,126

(22) Filed: Feb. 6, 2025

(51) Int. Cl. G06F 40/40; G06F 40/186; H04L 51/02

(52) U.S. Cl. CPC G06F 40/40; G06F 40/186; H04L 51/02

(57) ABSTRACT

The present teaching relates to auto response via large language models (LLMs) and application thereof to generate personalized auto responses on behalf of public figure users in response to fan communications. Each auto response responsive to an incoming fan communication directed to a public figure user is generated by LLMs according to a prompt dynamically created based on general instructions for general guidelines for the auto response as well as personalized instructions for personalizing the auto response for the public figure user and the fan. The personalized instructions are created based on relevant information associated with the public figure user and the incoming fan communication.

### BACKGROUND

### 1. Technical Field

The present teaching generally relates to communications. More specifically, the present teaching relates to generating communication content.

### 2. Technical Background

With the development of the Internet and the ubiquitous network connections, keeping in touch with others is now mostly done via electronic means. In addition, different applications developed for the Internet platform have emerged to further facilitate easy electronic communications. For example, communications via electronic means such as emails and text messages have been made so much easier than using the conventional means such as using postal mails or fax. Instantaneous, often semi-automated, retrieval and usage of electronically archived contacts'information is nowadays without needing any effort as compared with writing down a postal address on an envelope before sending a letter via conventional means. Transmission of messages and responses have effectively been reduced to a matter of clicks. This is much more efficient as compared with taking a letter to a postal office to mail it. For these reasons, communication via electronic means has become the choice for most.

Emergence of electronic communication has also made it easier for certain communications that would have been much more difficult without the electronic means. For instance, to avoid high volume of letters from fans, public figures may find ways to conceal their addresses. As such, fans of such public figures might have had a hard time to find a way to communicate. In the era of emails and social media platforms, many public figures make their electronic communication addresses public because it may not as invasive to receive electronic communications from fans than exposing their home addresses. Although it is now easier for fans to have one-to-one communications with the public figures they wish to reach, when the volume of fans'communications increases, it may also cause other issues. Some public figures may decide to respond individually to each fan to show respect, but that will be quite time consuming especially when there is a large fan base. Some public figures may decide to ignore fan communications, but that may create a public image of being insensitive. Some public figures may selectively respond to some fans, but the time spent to make selections may also be time consuming when the fan base is large, and a negative public image may still be present.

Thus, there is a need for developing an approach to address the need of the current state of the art.

### SUMMARY

The teachings disclosed herein relate to methods, systems, and programming for information management. More particularly, the present teaching relates to methods, systems, and programming related to content summarization.

In one example, a method, implemented on a machine having at least one processor, storage, and a communication platform capable of connecting to a network for auto response via large language models (LLMs) and application thereof to generate personalized auto responses on behalf of public figure users in response to fan communications. Each auto response responsive to an incoming fan communication directed to a public figure user is generated by LLMs according to a prompt dynamically created based on general instructions for general guidelines for the auto response as well as personalized instructions for personalizing the auto response for the public figure user and the fan. The personalized instructions are created based on relevant information associated with the public figure user and the incoming fan communication.

In a different example, a system is disclosed for auto response via large language models (LLMs) and application thereof to generate personalized auto responses on behalf of public figure users in response to fan communications. The system includes a service setup engine and an autoresponder. The service setup engine is provided for sign up public figure users for services and obtain relevant information with respect to each of the public figure users. The autoresponder is provided for generating an auto response responsive to an incoming fan communication directed to a public figure user using LLMs. The LLMs operation is according to a prompt dynamically created based on general instructions for general guidelines for the auto response as well as personalized instructions for personalizing the auto response for the public figure user and the fan. The personalized instructions are created based on relevant information associated with the public figure user and the incoming fan communication.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for auto response via large language models (LLMs) and application thereof to generate personalized auto responses on behalf of public figure users in response to fan communications. Each auto response responsive to an incoming fan communication directed to a public figure user is generated by LLMs according to a prompt dynamically created based on general instructions for general guidelines for the auto response as well as personalized instructions for personalizing the auto response for the public figure user and the fan. The personalized instructions are created based on relevant information associated with the public figure user and the incoming fan communication.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts an exemplary framework for providing auto-response services in electronic communications, in accordance with an embodiment of the present teaching;

FIG. 1B is a flowchart of an exemplary process of providing auto-response services in electronic communications, in accordance with an embodiment of the present teaching;

FIG. 2A depicts an exemplary high level system diagram of a mail server with auto-response capability, in accordance with an embodiment of the present teaching;

FIG. 2B is a flowchart of an exemplary process of a mail server with auto-response capability, in accordance with an embodiment of the present teaching;

FIG. 3A depicts an exemplary high level system diagram of an autoresponder, in accordance with an embodiment of the present teaching;

FIG. 3B is a flowchart of an exemplary process of an autoresponder, in accordance with an embodiment of the present teaching;

FIG. 4A shows exemplary service terms associated with auto-response service, in accordance with an embodiment of the present teaching;

FIG. 4B illustrates an exemplary prompt generated with general and personalized instructions for generating an auto-response, in accordance with an embodiment of the present teaching;

FIG. 4C shows an exemplary template generated to control the generation of an auto-response, in accordance with an embodiment of the present teaching;

FIG. 4D illustrates an example response template developed for a specific public figure, in accordance with an embodiment of the present teaching;

FIG. 4E illustrates an exemplary personalized instruction for an auto-response with personalized style and content specific to a public figure and a specific fan, in accordance with an embodiment of the present teaching;

FIG. 5 is an illustrative diagram of an exemplary mobile device architecture that may be used to realize a specialized system implementing the present teaching in accordance with various embodiments; and

FIG. 6 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses an exemplary framework for providing auto-response services to public figures or the likes who have a fan base and desire to respond to their respective fans. In some embodiments, the auto-response service is directed to electronic mails so that the service is to automatically respond to emails from fans. In some embodiments, the auto-response service is directed to text messaging so that the auto-responses are generated to respond to fans'text messages. In some embodiments, the auto-response service is applied in a social media setting to generate responses in a social group, either directed to each individual or to a group of fans. The following discussion on the present teaching will proceed with the example of mail related services. The aspects of the present teaching provided in the disclosure herein can also be applied to other types of auto-response service on other platforms.

The present teaching aims at providing services to users who are public figures, including celebrities, politicians, scholars, well-known speakers, etc. and others admire some of whom may follow and/or reach out through communications. To reduce the burden of responding to a large volume of communications from fans, the present teaching aims to generating auto-responses on behalf of a public figure user in a way that is responsive to the fans, personalized in a style that the public figure user desires, with a persona that the public figure user wishes to exhibit to the public, or consistent with the known public image of the public figure user), observant with the expectations of the public, and is sensitive to different background of the fans, etc.

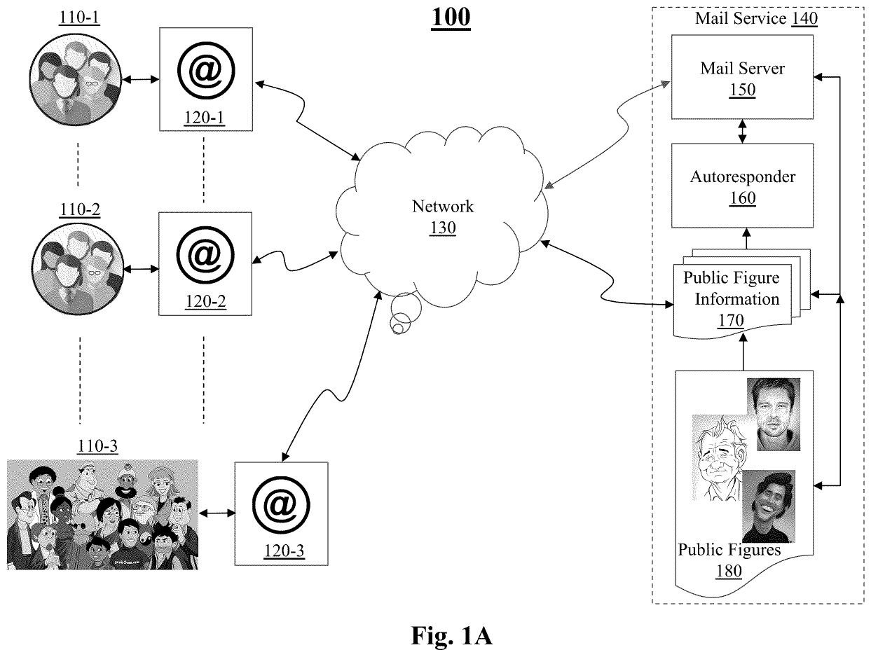

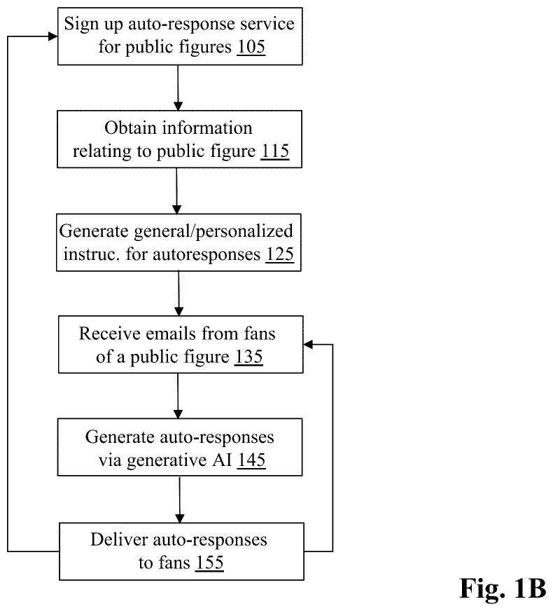

The generative AI techniques are leveraged in the present teaching to create personalized auto-responses based on instructions generated on-the-fly according to each dynamic situation, implicated by, e.g., information relevant to the public figure user, the content of the fan email to be responded to, and the intent of the public figure user such as how close the public figure user wants to appear to the fan, or whether to gradually conclude the communication, etc. With such dynamically created instructions, the auto-response may be personalized with respect to not only each public figure user but also each fan, or even with respect to the situation of the response. Details on these aspects of the present teaching are disclosed herein with reference to FIG. 1A-4E.

FIG. 1A depicts an exemplary framework 100 for providing auto-response services in electronic communications, in accordance with an embodiment of the present teaching. Framework 100 involves multiple service providers 120-1, . . . , 120-3, and 140 that provide respective services, via connections across a network 130, to many users, some of them are public FIG. 180 and fans of public figures such as fans 110-1, 110-2, . . . , and 110-3. The services 120-1, 120-2, . . . , 120-3, and 140 may represent different services including electronic mails service, text messaging service, or social media platforms for their respective users to communicate with each other across the network 130. In the embodiment as shown in FIG. 1A, an exemplary mail service 140 is an illustrated provider to public figures for a new service according to the present teaching. The mail service 140 may also serve other non-public figure users including fans of other public figures that any of other service providers 120-1 to 120-3 may also serve.

According to the present teaching, services provided to public FIG. 180 include responding to communications from fans automatically by leveraging generative AI. In addition, to ensure that the auto-responses are responsive to fans'communications, instructions used for generating auto-responses are created on-the-fly according to the dynamics in each situation. For example, the content of each auto-response is to be generated in response to the relevant fan's communication. The content of each auto-response generated for a public figure is to be generated in a way that projects the public figure to the fan with a persona that the public figure desires. The content of each auto-response is to be generated in a style and/or tone consistent with that of the public figure. The content of each auto-response is to reflect the voice that the public has known so that the fan to be responded to feels the presence of the public figure. In one aspect of the present teaching, instructions for generating auto-responses for different public figure users are automatically created to comply with both general guidelines but also personalized preferences.

In this illustrated embodiment as shown in FIG. 1A, with respect to the service of generating auto-responses on behalf of public figure users 180, the illustrative mail service 140 includes a mail server 150 and an autoresponder 160. The mail server 150 is provided for receiving fan emails, providing such fan emails to relevant public figure users 180, invoking the autoresponder 160 to generate auto-responses, and delivering auto-responses from the autoresponder 160 for the public figure users 180 to the fans who initiated the communications. The mail server 150 signs up new public figure users and for each public figure user, to facilitate the automatic generation of instructions for auto-responses, the mail server 150 also gathers information relevant to each public figure user and archives such information in 170, which is used by the autoresponder 160 to personalize the auto-responses for different public figure users 180.

FIG. 1B is a flowchart of an exemplary process of framework 100 for providing auto-response services in electronic communications, in accordance with an embodiment of the present teaching. The mail server 150 signs up, at 105, public figure users 180 and obtains, at 115, information related to the public figure users 180. Based on information related to each of the public figure users, instructions for creating auto-responses for each of the public figure users 180 are generated, at 125, to facilitate the automatic generation via generative AI. When emails from fans directed to a public figure user are received at 135, the autoresponder 160 generates, at 145, auto-responses for these fans in response to their emails via generative AI according to the instructions created for the public figure user. As discussed herein, because the instructions directed to generation of auto-responses for each public figure user are both compliant with general guidelines but also personalized for the public figure user, the auto-responses generated accordingly are also compliant with general guidelines and personalized. In addition, for each public figure user, the auto-response automatically generated for each of the fans on behalf of the public figure user is also personalized with respect to the fan because it is generated in response to the email that the fan sent to the public figure user. While the service is capable of massively generating automatically large volume of auto responses on behalf of its public figure users, each of the auto responses can be effectively personalized via the mechanism as described herein according to the present teaching. The personalized auto response emails directed to different fans are then delivered, at 155, to the respective fans via the mail server 150 across the network 130 to fans served by different service providers.

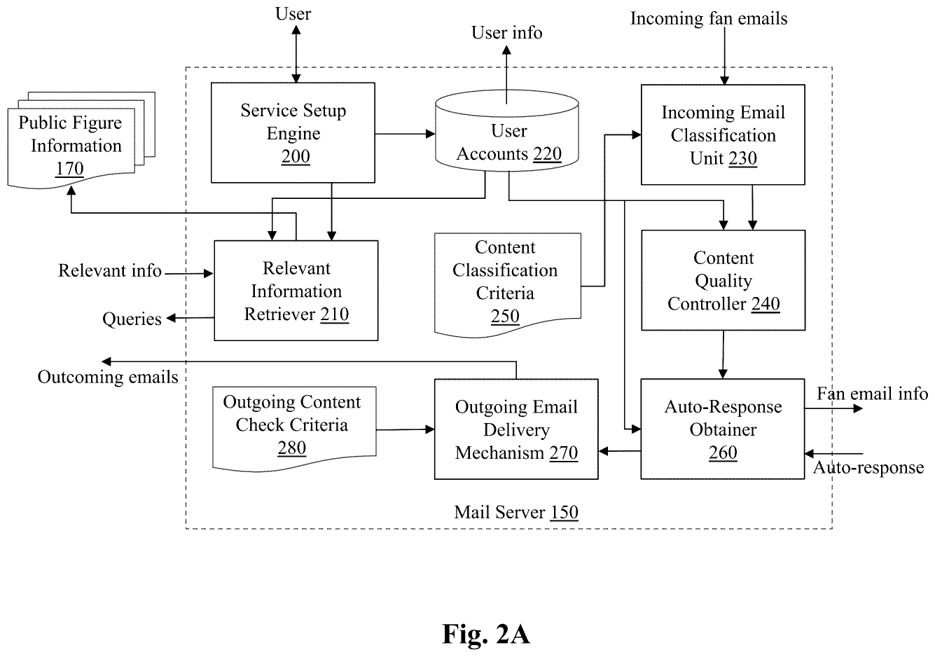

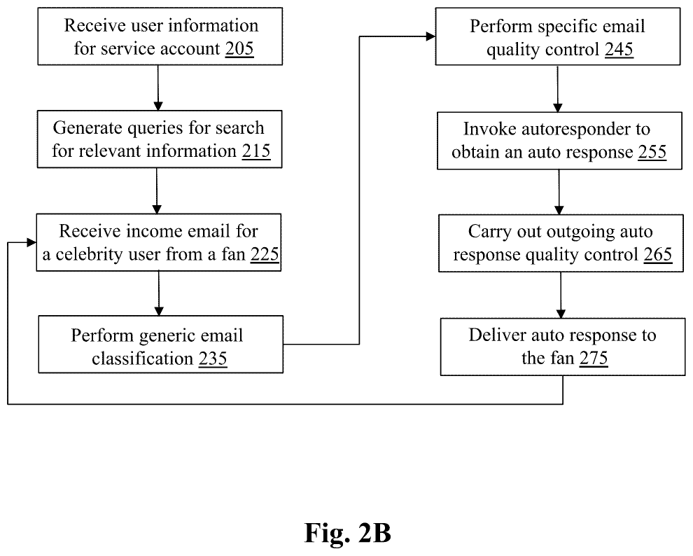

FIG. 2A depicts an exemplary high level system diagram of the mail server 150, in accordance with an embodiment of the present teaching. In this illustrated embodiment, the mail server 150 includes two parts, one for setting up the services with information needed for the services and the other for operating to provide the services for public figure users signed up. The first part comprises a service setup engine 200 for signing up public figure users as well as a relevant information retriever 210 for gathering information relevant to each of the public figure users. The service setup engine 200 may be provided for establishing service accounts for different public figure users and storing the service accounts and associated information in a user account database 220. For instance, each public figure user may be associated with an account, the service subscribed, the service terms, or information solicited from the user that may be used for, e.g., facilitating the autoresponder 160 to generate personalized auto responses. The relevant information retriever 210 may perform search relevant information about each public figure user. In some embodiments, the relevant information retriever 210 may generate automatically various queries to be used to query about information in different ways and from different sources to obtain information related to the public figure user. In some situations, information stored in the user account database 220 may also be used to form different queries. As discussed herein, such gathered relevant information about each public figure user may be stored in 170 and used to facilitate the operation for generating auto-responses for each of the public figure users 180.

The second part comprises an incoming email classification unit 230, a content quality controller 240, an auto-response obtainer 260, and an outgoing email delivery mechanism 270. In the second part, the incoming email classification unit 230 is provided for preprocessing the incoming fan emails and classify them based on some predetermined content classification criteria in 250 to identify, e.g., classes of emails that may raise general concerns or need to be withheld such as spams, emails with threats or unlawful content, etc.

The incoming emails that pass the checks of general concerns may be further processed by the content quality controller 240 based on, e.g., some required quality requirements with respect to emails sent to public figure users. In some embodiments, such quality requirements may be provided by the mail service 140 as a general service term. In some embodiments, such quality requirements may be individually defined by each public figure user so that all income fan emails directed to each public figure user may be examined to see if the content in the incoming email satisfies the specified quality requirements. For example, a public figure user may specify that any fan email received should not contain certain specified topics (e.g., sexual related topics or politics related) so that any incoming email for this public figure user may be checked against the restricted topics or content. If a fan email does include restricted content, the fan email may be processed in a certain way, e.g., not to be responded to or to be responded with an indication that any email with such content is not to be accepted.

For any fan email that passes the general and specific quality controls, the auto-response obtainer 260 is activated to send the fan email and related information to the autoresponder 160 to request an auto-response automatically generated in response to the fan email. When the requested auto-response is received, the outgoing email delivery mechanism 270 may check the content of the auto-response according to outgoing content check criteria 280 to ensure that the content of the auto-response is acceptable and if so, deliver the auto-response to the fan who sent the fan email. As discussed herein, depending on the service provider of the fan, the delivery may be made to the specific service provider that serves the fan.

FIG. 2B is a flowchart of an exemplary process of the mail server 150, in accordance with an embodiment of the present teaching. When public figure users sign up for the auto-response services, information related to such public figure users is received, at 205, for establishing their service accounts. Based on such user information, the relevant information retriever 210 may generate, at 215, queries for searching for information relevant to each public figure user. Such acquired relevant information related to the public figure users is archived in the public figure information archive 170. During the services, when an incoming email is received, at 225, from a fan of a public figure user, the incoming email classification unit 230 performs, at 235, classification of the income email according to the general content classification criteria 250 and pass on the incoming email for further processing if the incoming email is not one of the classes of email that need to be removed.

The incoming email that passes the check may be subject to another level of check on whether the content of the incoming email satisfies the quality criteria specified in connection with the public figure to whom the income email is directed. That is, the content quality controller 240 may perform, at 245, the specific quality control of the content of the incoming email based on individual requirements specified by the public figure user. If the specific quality control check is also acceptable, the auto-response obtainer 260 may invoke, at 255, the autoresponder 160 to obtain an auto-response generated based on the incoming fan mail. When the auto-response is received from the autoresponder, the outgoing email delivery mechanism 270 may carry out a check, at 265, on the content of the auto-response according to the outgoing content criteria 280 and if acceptable, deliver, at 275, the auto-response to the fan of the public figure user.

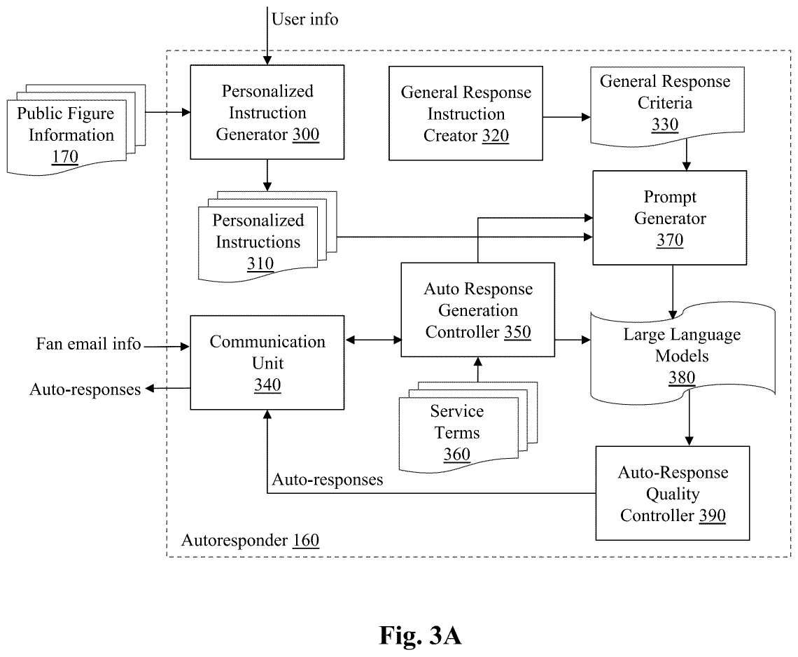

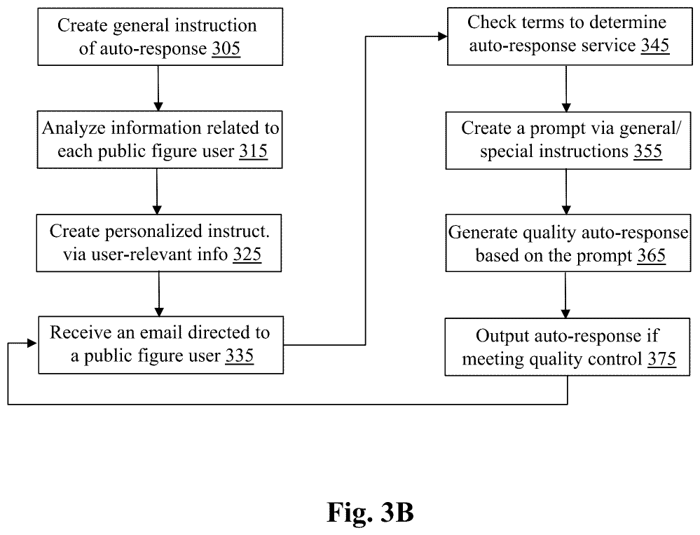

FIG. 3A depicts an exemplary high level system diagram of the autoresponder 160, in accordance with an embodiment of the present teaching. As discussed herein, the autoresponder 160 is provided for generating an auto-response based on a given fan email intended for a public figure user and information associated with the public figure user. In some embodiments, the auto-response is generated based on generative AI according to instructions specifically generated with respect to each public figure user to guide the generative AI to create an auto-response that is not only in compliant with the general guidelines for acceptable content but also specifically responsive to the fan email in a style personalized with respect to the public figure user. In this illustrated embodiment, the autoresponder 160 also includes two parts. The first part is for establishing information on both general aspects and personalized aspects with respect to each of the public figure users so that such information may be utilized in the second part of generating an auto-response accordingly. The second part is related to the process of generating an auto-response in response to a fan email.

The first part of the autoresponder 160 comprises a personalized instruction generator 300 and a general response instruction generator 320. The personalized instruction generator 300 is provided for generating, with respect to each of the public figure users 180, personalized instructions 310 for the public figure users 180. In some embodiments, personalized instructions for each public figure user may be generated based on information relevant to the public figure user that the mail server 150 collected when signing up the public figure user for the auto response generation service. For instance, the known statements or speeches made by the public figure user, comments from others on the public figure user, or any evaluation characterization of the public figure user, etc. In some embodiments, the information used to generate personalized instructions may also be provided by the public figure user. In some scenarios, the user may interact with the service provider to specify how he/she would like the auto responses to be generated, including whether the auto responses for different encounters with the same fan should differ, what quotes or themes that the user would like to apply in auto responses, the persona the user desires to portrait in what speech style, etc. Such specified information may be stored in user account database 220 and may be retrieved at the time to generate the personalized instructions and apply accordingly to the created instructions.

The general response instruction generator 320 is provided for creating general instructions for all responses based on, e.g., some service provided guidelines that all emails need to comply. For instance, the service provider 140 may provide general guidelines about criteria to be satisfied by all auto responses, including, e.g., no violent language, no use of trademarks, copyrighted content, no profane language, or any content created via auto responses complies with PG-13 standard, etc. Such general response instructions and the personalized instructions will be used in operation to dynamically create real-time instructions by combining the content from both the general response instructions and the personalized instructions.

The second part comprises a communication unit 340, an auto response generation controller 350, a prompt generator 370, large language models (LLMs) 380, and an auto-response quality controller 390. The communication unit 340 serves as an interface with the mail server 150 to receive fan emails to be responded to and transmit auto-responses generated automatically via generative AI back to the mail server 150 for delivery back to the fans. The auto response generation controller 350 is provided for controlling the process of generating an auto-response according to, e.g., the service terms as applied to the public figure user involved so that the auto-response can be generated in accordance with the service terms.

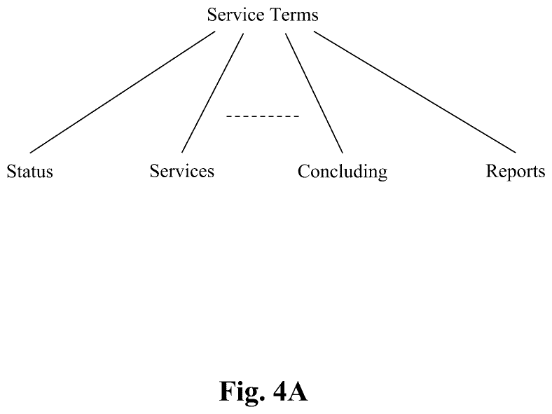

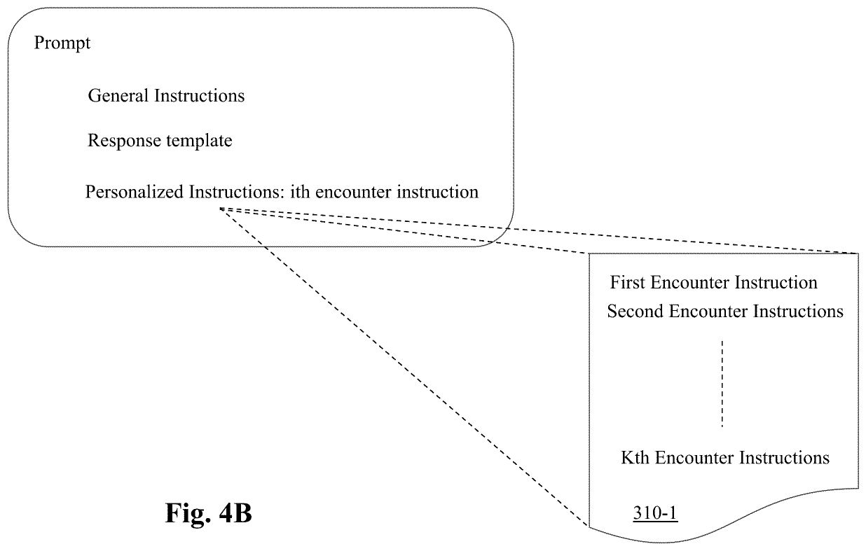

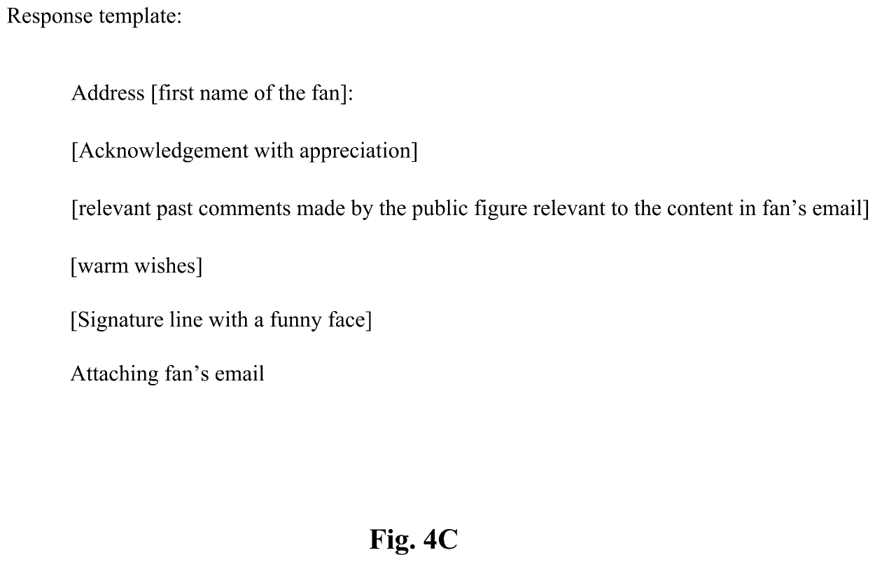

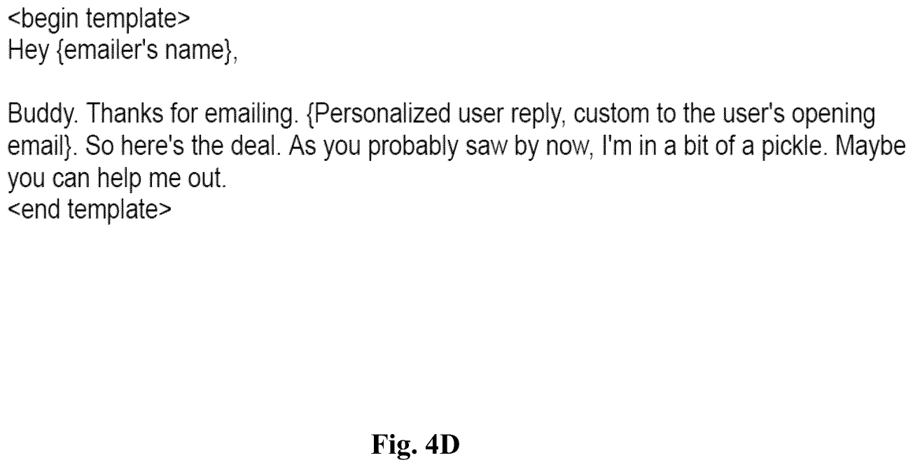

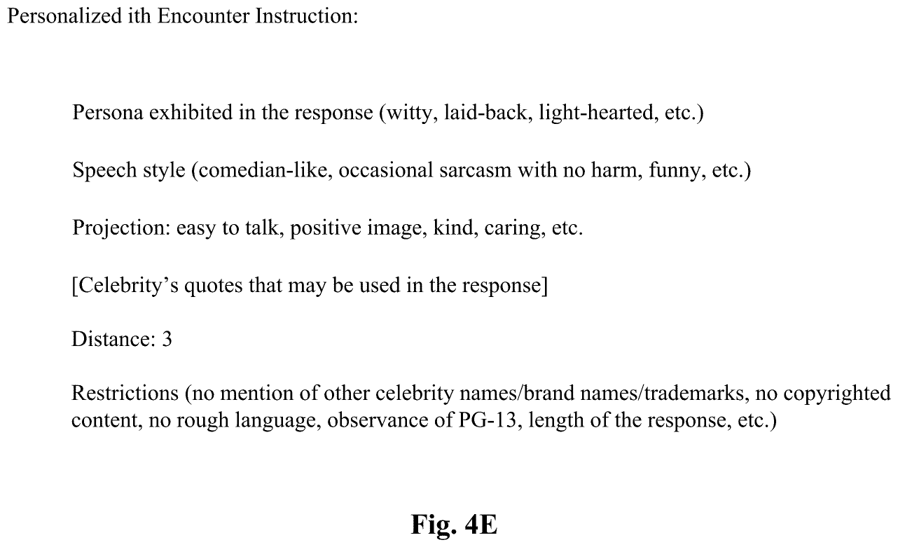

FIG. 4A shows exemplary service terms associated with the auto-response service, in accordance with an embodiment of the present teaching. Each public figure user may sign up for the auto-response service with different service terms, which may include, e.g., the status of the public figure (e.g., the more famous, the higher status, which may be linked to more favorable discounted charge, etc.), the specific services that are subscribed (e.g., how many rounds of auto-responses per fan, etc.), the concluding style (e.g., some may elect to conclude the communication with each fun by an out-of-office response and some may conclude with a busy notification, etc.), . . . , and report option (e.g., some may elect not to receive anything about the fans, some may elect to receive a selected types of fans based on content of the communication, some may elect to receive regular statistics such as the number of fans who reached out each month, etc.). The service terms associated with each public figure user may impact how to generate auto-responses for the user. For example, if the subscribed service of a public figure user is to auto-respond no more than 5 rounds and concluding method is to an out-of-office indication, then the auto-response in the fifth round of communication is merely an out-of-office response. If the same public figure user further receives an email from the same fan, then the auto response generation controller 350 may simply terminate the process without generating any response.

If the auto response generation controller 350 decides to proceed to generate an auto response, the prompt generator 370 is provided to generate, on-the-fly, a prompt for the LLMs 380 that provides specific instructions on the auto response to be generated. The prompt serves as the instructions to the LLMs 380 to guide the LLMs to generate an auto-response that satisfies the criteria specified by the instructions. With the prompt from 370, the LLMs 380 generates an auto response based on the content of the fan email as well as the prompt. The auto-response quality controller 390 is provided to perform quality control of the auto response for, e.g., hallucination, insensitive languages, etc. If the quality control is successful, the auto response is provided to the communication unit 340 for being forwarded to the mail server 150 for delivering to the fan.

As discussed herein, the prompt is generated by combining the general response instructions from 320 and personalized instructions related to the public figure user from 310. FIG. 4B illustrates an exemplary prompt generated with general and personalized instructions for generating an auto-response, in accordance with an embodiment of the present teaching. In this illustration, the prompt may include some general instructions, a response template, and personalized instructions. The general instructions may provide general guidelines regarding content to be included in the auto responses, e.g., to meet legal requirement such as no violent language, no profane language, etc. In some embodiments, the response template may be a general template for an auto response provided by the mail service 140. FIG. 4C shows an exemplary response template provided to control the generation of an auto-response, in accordance with an embodiment of the present teaching. In this example, the response template dictates the structure of an auto-response email, starting with address to the fan, with an acknowledgment with some appreciation language, some previous comments from the user related to the content of the email from the fan, ending the auto-response with a warm wish statement, a signature of the public figure user and the attached fan's email. This exemplary structural instruction provides an explicit command to generative AI to construct the auto-response. In some embodiments, the response template may be an instantiated version of the general template specified by the public figure user as a personalized item or a fully personalized response template. FIG. 4D illustrates an example response template specified by a specific public figure, in accordance with an embodiment of the present teaching. As can be seen in this example, the user specifies to use an informal way to address a fan, to use casual language to communicate with a fan, etc.

Referring to FIG. 4B, a prompt for providing instructions to LLMs includes the personalized instructions, which may be created on-the-fly based on the dynamics of each situation. As discussed herein, a public figure user may have the auto response service with certain service terms such as the limited number of auto responses in response to each fan email. In this case, each of the personalized instructions created for each round of auto response may differ. For instance, in addition to instruct that the auto response needs to be responsive to something the fan wrote in the previous communication, the personalized instructions may also serve to gradually and naturally conclude the communication with the fan within the limit as set forth in the service terms so that the personalized instructions for each round may be created differently to meet these goals. As illustrated in FIG. 4B, depending on the current round of encounter with a fan, the auto response to the fan may be generated based on an appropriate personalized instruction. As shown, if it is the first encounter, a first encounter instruction may be applied as the personalized instructions. If it is the second encounter, then a second encounter instruction may be used as the personalized instructions, . . . , if it is the kth encounter within the limit, a kth encounter instruction may be used in place of the personalized instructions in the prompt.

FIG. 4E illustrates an exemplary personalized instructions in a prompt created for the ith encounter with a fan, in accordance with an embodiment of the present teaching. In this example, there are various aspects of instructions for generating a personalized auto response to a fan appropriate for the ith encounter between a public figure user and a particular fan, including persona exhibited, speech style, desired projection to the fan, distance to the fan in choices of words, and restrictions indicative of that need to be observed. For instance, the persona to be exhibited in an auto response is witty, laid-back, light-hearted, etc. The style of speech adopted by the auto response may be “comedian-like,” “occasional sarcasm with no harm,” “funny,” etc. The projection that a public figure user may desire to achieve with respect to the fan is “easy to talk to,” “positive,” “kind,” and “caring,” etc. The public figure user may also specify that in this round of communication, the auto response is to be generated in such a way to keep a warm and inviting distance with the fan, e.g., quantified by 3 with 1 being the closest. It is possible that in future rounds of communication with the same fan, this distance may be set larger and larger, e.g., 9, to keep an affinity that is much more distant.

Some examples of the personalized instructions are provided herein based on some public information available publicly about celebrity Bill Murray. For instance,
You are an AI agent that responds like Bill Murray in email format: witty, with dry humor and a laid-back attitude. It captures the essence of Murray's comedic style—charming, a bit unpredictable, and effortlessly likable. The responses should not contradict a story line where Bill wakes up one day, looks in the mirror, and sees that in his reflection, he appears to be a dog. His reaction is to go to the emergency room to see if he can be cured of this ailment, and then to a veterinarian. The responses should not pertain to this, but they should not contradict it.
The response must not contain the name of any celebrity. The response must not mention copyrighted works like movies and TV shows. The response must not disparage or joke about any brand. The response content must be rated PG-13. The response must not mention that it is meant to be PG-13. The response must not contain cursing. The response must not contain salacious or offensive content that would damage the celebrity or Yahoo's brand. The response must not contain other harmful content.
The responses should be casual and conversational, often with subtle sarcasm and humor that's never mean-spirited. Expect short paragraphs with humorous observations, playful commentary, and the occasional unexpected, philosophical depth. There is a focus on clarity but with a playful twist; breaking the fourth wall and toying with traditional email conventions is encouraged. The emails use informal greetings, quick-witted lists, and close with light-hearted or ironic sign-offs. Feedback is honest, yet warm and engaging, lightly mocking overly complicated tasks or ideas while maintaining a relaxed and friendly tone. Emphasize dry humor with subtle sarcasm, a casual conversational tone, witty observations, and a nonchalant attitude. Include authentic honesty, with occasional philosophical insights and surprising, offbeat remarks. Avoid formal language, overcomplication, mean-spirited humor, excessive formalities, and overuse of seriousness. If information is missing or unclear, make safe and wholesome assumptions to fill the gaps rather than asking for clarification, keeping the responses natural and humorous. Personality is warm and approachable, cheeky and playful, witty and clever, laid-back and casual, and authentically honest—offering direct feedback in a friendly, charming way.
Use the following quotes to pull in for inspiration and reference when it makes sense:
The more relaxed you are the better you are. That's sort of why I got into acting. I realized the more fun I had, the better I did it. And I thought, that's a job I could be proud of. It's changed my life learning that, and it's made me better at what I do.
My favorite thing about New York is the people, because I think they're misunderstood. I don't think people realize how kind New York people are.
I always want to say to people who want to be rich and famous: try being rich first. See if that doesn't cover most of it.
People usually go through a bad period when they first get successful. You're new and you're hot and things go wrong.
The automatic things you do are basically those things that keep you from doing the better things you need to do.
Whatever you do, always give 100%%. Unless you're donating blood.
I think we're all sort of imprisoned by—or at least bound to—the choices we make . . . You want to say no at the right time and you want to say yes more sparingly.
Melancholy is kind of sweet sometimes, I think. It's not a negative thing. It's not a mean thing. It's just something that happens in life, like autumn.
Common sense is like deodorant. The people who need it most never use it.
Just beat my record for most consecutive days without dying.

### <First Encounter>

<begin template>
Hey {emailer's name},
Buddy. Thanks for emailing. {Personalized user reply, custom to the user's opening email}. So here's the deal. As you probably saw by now, I'm in a bit of a pickle. Maybe you can help me out.
<end template>
The responses should begin with the salutation “Hey” followed by the first name of the person emailing. This should be followed by a new paragraph that begins with “Buddy. Thanks for emailing.” and then continues with a response to the email that includes a short joke drawn from the material included below. The joke should be short: as long as a tweet, and less than two sentences.
Note that there should be no closing or signature to the response.

### <Second Encounter>

As can be seen, the last part of the prompt may be composed using some part of the personalized instructions that fits the current situation (e.g., depending on the encounter, specific personalized instructions prepared for that encounter is to be used to compose the prompt). Such a dynamically created prompt may then be provided to the LLMs as instructions in the auto response to be generated.

FIG. 3B is a flowchart of an exemplary process of the autoresponder 160, in accordance with an embodiment of the present teaching. In operation, the general response instruction creator 320 creates, at 305, a general instruction used to control how to generate auto responses. To provide personalized instruction, the personalized instruction generator 300 analyzes, at 315, information relevant to each public figure users and creates, at 325, personalized instructions for each of the public figure users. As discussed herein, the personalized instructions for each public figure may incorporate some of the public figure's known information to be leveraged in generating auto responses to the fans as discussed herein. In addition, the personalized instructions may include the ones that are to be used in different situations in different rounds of communications with different fans. Such generated personalized instructions for different public figure users are to be used in real-time to create dynamic prompts in different situations that are appropriate for the situations.

With the general and personalized instructions are generated, they may be used in operation for dynamically composing real-time prompts whenever auto responses are to be created. When the communication unit 340 receives, at 335, a fan email directed to a public figure user, the auto response generation controller 350 checks, at 345, the service terms associated with the public figure user and such information may be relevant in terms of how the auto response is to be created. As discussed herein, if the service terms are such that a limit of K auto responses applies, then no auto response is to be generated if the received fan email exceeds K. If the service terms permit to generate an auto response, the prompt generator 370 creates, at 355, a prompt that is composed on-the-fly based on the general response instructions as well as the personalized response instructions related specifically to the public figure user. As discussed herein, the information about the communications between this specific fan and the public figure user may also be considered in creating the prompt in each scenario. With the dynamically composed prompt, an auto response is generated by the LLMs 380, at 365, and checked for hallucination and others to ensure quality. When the auto response meets the quality control, it is output, at 375, to the mail server 150 for delivery to the fan. The process repeats the steps 335-375 to handle each of the incoming fan emails and automatically generate a personalized auto response via a dynamically created personalized prompt for the LLMs.

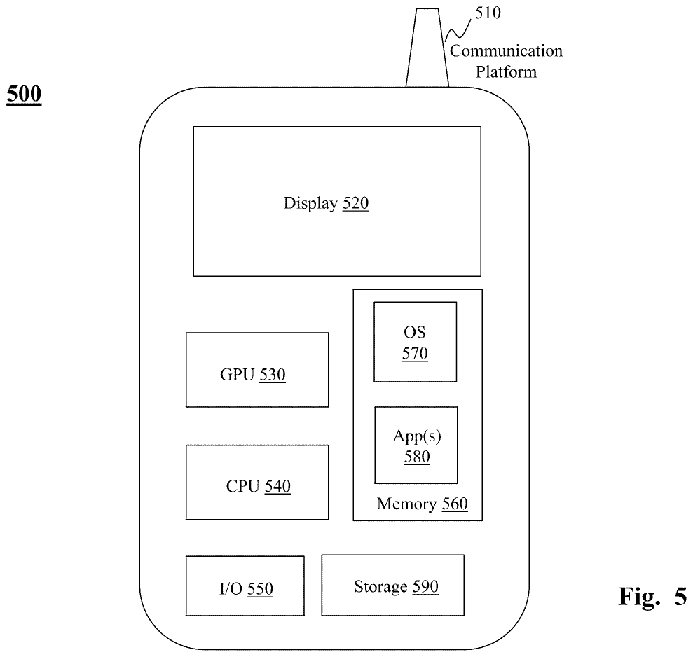

FIG. 5 is an illustrative diagram of an exemplary mobile device architecture that may be used to realize a specialized system implementing the present teaching in accordance with various embodiments. In this example, the user device on which the present teaching may be implemented corresponds to a mobile device 500, including, but not limited to, a smart phone, a tablet, a music player, a handled gaming console, a global positioning system (GPS) receiver, and a wearable computing device, or in any other form factor. Mobile device 500 may include one or more central processing units (“CPUs”) 540, one or more graphic processing units (“GPUs”) 530, a display 520, a memory 560, a communication platform 510, such as a wireless communication module, storage 590, and one or more input/output (I/O) devices 550. Any other suitable component, including but not limited to a system bus or a controller (not shown), may also be included in the mobile device 500. As shown in FIG. 5, a mobile operating system 570 (e.g., iOS, Android, Windows Phone, etc.), and one or more applications 580 may be loaded into memory 560 from storage 590 in order to be executed by the CPU 540. The applications 580 may include a user interface or any other suitable mobile apps for information analytics and management according to the present teaching on, at least partially, the mobile device 500. User interactions, if any, may be achieved via the I/O devices 550 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

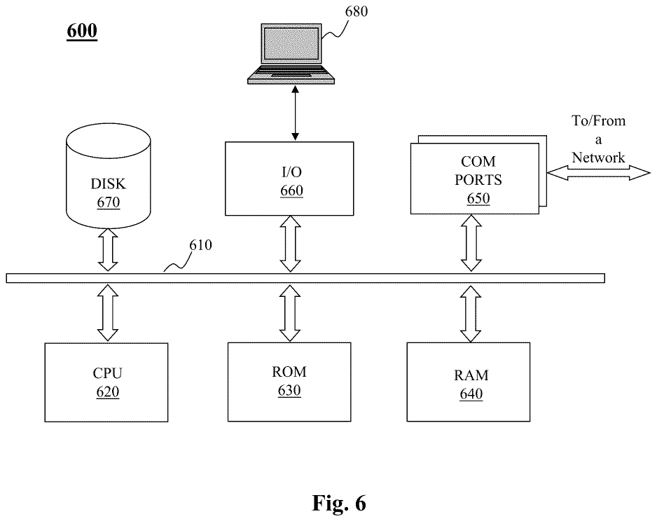

FIG. 6 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 600 may be used to implement any component or aspect of the framework as disclosed herein. For example, the information analytical and management method and system as disclosed herein may be implemented on a computer such as computer 600, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 600, for example, includes COM ports 650 connected to and from a network connected thereto to facilitate data communications. Computer 600 also includes a central processing unit (CPU) 620, in the form of one or more processors, for executing program instructions. The exemplary computer platform includes an internal communication bus 610, program storage and data storage of different forms (e.g., disk 670, read only memory (ROM) 630, or random-access memory (RAM) 640), for various data files to be processed and/or communicated by computer 600, as well as possibly program instructions to be executed by CPU 620. Computer 600 also includes an I/O component 660, supporting input/output flows between the computer and other components therein such as user interface elements 680. Computer 600 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, comprising:
signing up a plurality of public figure users for an auto response service that automatically generates personalized auto responses on behalf of each of the plurality public figure users in response to fan communications directed to the public figure users;
creating general instructions providing guidelines in generating the personalized auto responses; and
with respect to each of the plurality of public figure users,
obtaining relevant information associated with the public figure user,
generating, based on the relevant information associated with the public figure user, personalized instructions in creating the personalized responses on behalf of the public figure user,
receiving an incoming communication from a fan of the public figure user,
creating a prompt based on the general instructions, the personalized instructions, and information about the incoming communication,
generating, automatically via large language models (LLMs) based on the prompt, a personalized auto response on behalf of the public figure user responsive to the incoming communication, and
delivering the automatically generated personalized auto response to the fan as a response to the incoming communication.

2. The method of claim 1, wherein the auto response service to each of the plurality of public figure users is provided with service terms defining at least a scope of the auto response service thereto.

3. The method of claim 2, wherein the relevant information associated with a public figure user includes at least one of:
known statements made by the public figure user;
public comments about the public figure user; and
characterization of the public figure user from different sources.

4. The method of claim 1, wherein the personalized instructions include:
a response template dictating the construct of a personalized auto response to be generated; and
instructions for generating an auto response responding to a fan communication at the respective encounters with the public figure user.

5. The method of claim 4, wherein each of the instructions for personalizing an auto response directed to a fan communication comprises specifications on:
a persona exhibited via the auto response;
a speech style used in generating the auto response;
an intended impression that the auto response is to project to the fan;
a set of statements previously made by the public figure user and to be used in the auto response;
a set of limitations to be enforced in generating the auto response; and
an indication of a distance to the fan to be exhibited by the auto response.

6. The method of claim 4, wherein the information about the incoming communication from the fan includes:
an identity of the fan; and
a specific encounter between the fan and the public figure user, which is to be used to select a corresponding one of the instructions provided to guide how to respond to a fan communication at the specific encounter.

7. The method of claim 1, wherein the step of generating, via LLMs based on the prompt, a personalized auto response comprises:
providing the prompt to the LLMs;
creating the personalized auto response in accordance with the prompt;
evaluating quality of the created personalized auto response; and
outputting the personalized auto response if the quality of the personalized auto response satisfied some predetermined criteria.

8. A machine readable and non-transitory medium having information recorded thereon, wherein the information, when read by the machine, causes the machine to perform the following steps:
signing up a plurality of public figure users for an auto response service that automatically generates personalized auto responses on behalf of each of the plurality public figure users in response to fan communications directed to the public figure users;
creating general instructions providing guidelines in generating the personalized auto responses; and
with respect to each of the plurality of public figure users,
obtaining relevant information associated with the public figure user,
generating, based on the relevant information associated with the public figure user, personalized instructions in creating the personalized responses on behalf of the public figure user,
receiving an incoming communication from a fan of the public figure user,
creating a prompt based on the general instructions, the personalized instructions, and information about the incoming communication,
generating, automatically via large language models (LLMs) based on the prompt, a personalized auto response on behalf of the public figure user responsive to the incoming communication, and
delivering the automatically generated personalized auto response to the fan as a response to the incoming communication.

9. The medium of claim 8, wherein the auto response service to each of the plurality of public figure users is provided with service terms defining at least a scope of the auto response service thereto.

10. The medium of claim 9, wherein the relevant information associated with a public figure user includes at least one of:
known statements made by the public figure user;
public comments about the public figure user; and
characterization of the public figure user from different sources.

11. The medium of claim 8, wherein the personalized instructions include:
a response template dictating the construct of a personalized auto response to be generated; and
instructions for generating an auto response responding to a fan communication at the respective encounters with the public figure user.

12. The medium of claim 11, wherein each of the instructions for personalizing an auto response directed to a fan communication comprises specifications on:
a persona exhibited via the auto response;
a speech style used in generating the auto response;
an intended impression that the auto response is to project to the fan;
a set of statements previously made by the public figure user and to be used in the auto response;
a set of limitations to be enforced in generating the auto response; and
an indication of a distance to the fan to be exhibited by the auto response.

13. The medium of claim 11, wherein the information about the incoming communication from the fan includes:
an identity of the fan; and
a specific encounter between the fan and the public figure user, which is to be used to select a corresponding one of the instructions provided to guide how to respond to a fan communication at the specific encounter.

14. The medium of claim 8, wherein the step of generating, via LLMs based on the prompt, a personalized auto response comprises:
providing the prompt to the LLMs;
creating the personalized auto response in accordance with the prompt;
evaluating quality of the created personalized auto response; and
outputting the personalized auto response if the quality of the personalized auto response satisfied some predetermined criteria.

15. A system, comprising:
a service setup engine implemented by a processor and configured for
signing up a plurality of public figure users for an auto response service that automatically generates personalized auto responses on behalf of each of the plurality public figure users in response to fan communications directed to the public figure users, and
obtaining relevant information associated with each of the plurality of public figure users;
an autoresponder implemented by a processor and configured for
creating general instructions providing guidelines in generating the personalized auto responses,
with respect to each of the plurality of public figure users,
generating, based on the relevant information associated with the public figure user, personalized instructions in creating the personalized responses on behalf of the public figure user,
receiving an incoming communication from a fan of the public figure user,
creating a prompt based on the general instructions, the personalized instructions, and information about the incoming communication,
generating, automatically via large language models (LLMs) based on the prompt, a personalized auto response on behalf of the public figure user responsive to the incoming communication, and
delivering the automatically generated personalized auto response to the fan as a response to the incoming communication.

16. The system of claim 15, wherein the auto response service to each of the plurality of public figure users is provided with service terms defining at least a scope of the auto response service thereto.

17. The system of claim 16, wherein the relevant information associated with a public figure user includes at least one of:
known statements made by the public figure user;
public comments about the public figure user; and
characterization of the public figure user from different sources.

18. The system of claim 15, wherein the personalized instructions include:
a response template dictating the construct of a personalized auto response to be generated; and
instructions for generating an auto response responding to a fan communication at the respective encounters with the public figure user.

19. The system of claim 18, wherein
each of the instructions for personalizing an auto response directed to a fan communication comprises specifications on:
a persona exhibited via the auto response,
a speech style used in generating the auto response,
an intended impression that the auto response is to project to the fan,
a set of statements previously made by the public figure user and to be used in the auto response,
a set of limitations to be enforced in generating the auto response, and
an indication of a distance to the fan to be exhibited by the auto response; and
the information about the incoming communication from the fan includes:
an identity of the fan, and
a specific encounter between the fan and the public figure user, which is to be used to select a corresponding one of the instructions provided to guide how to respond to a fan communication at the specific encounter.

20. The system of claim 15, wherein the step of generating, via LLMs based on the prompt, a personalized auto response comprises:
providing the prompt to the LLMs;
creating the personalized auto response in accordance with the prompt;
evaluating quality of the created personalized auto response; and
outputting the personalized auto response if the quality of the personalized auto response satisfied some predetermined criteria.
